(19) United States
(12) Patent Application Publication
(10) Pub. No.: US 2009/0259820 A1
(43) Pub. Date: Oct. 15, 2009

(54) OPERATION METHOD FOR MEMORY

(75) Inventor: Chuan-Jen Chang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NANYA TECHNOLOGY CORPORATION, Taoyuan (TW)

(21) Appl. No.: 12/137,545

(22) Filed: Jun. 12, 2008

(30) Foreign Application Priority Data
Apr. 14, 2008 (TW) 97113494

(51) Int. Cl. G06F 1/24

(52) U.S. Cl. 711/166

(57) ABSTRACT

An operation method for a memory is provided. When the memory is under a reset mode, a main data line (MDQ) and a local data line (LDQ) of the memory is forced to be a logic high level. Then, the memory cells in the memory are turned on by choosing corresponding column selection lines (CSL) and corresponding word lines of the memory. Finally, the turned on memory cells are reset after the logic high level of the main data line and the local data line is written into the turned on memory cells.

### CROSS-REFERENCE TO RELATED APPLICATION

This application claims the priority benefit of Taiwan application serial no. 97113494, filed on Apr. 14, 2008. The entirety of the above-mentioned patent application is hereby incorporated by reference herein and made a part of specification.

### BACKGROUND OF THE INVENTION

1. Field of the Invention

The present invention generally relates to an operation method for a memory, in particular, to a memory cell reset method adapted to a dynamic memory.

2. Description of Related Art

In the past, memories employed in personal computers are synchronous dynamic random access memories (SDRAM). The SDRAM accesses data at the rising edge of the system clock signal.

Further, currently, a new architecture Double Data Rate SDRAM (DDR SDRAM) has been developed. This DDR SDRAM accesses data at both the rising edge and falling edge of the system clock signal. Therefore, the DDR SDRAM has a better performance than the conventional SDRAM, and has been gradually popularized.

To meet the users' demands for data transmission, the DDR SDRAM is transitioning from the first-generation DDR1, the second-generation DDR2 into the current third-generation DDR3. The DDR3 is characterized by the function of restoring the initial states of the read/write signal and the address signal under a reset mode.

The present invention provides an operation method for a memory, capable of restoring the initial states of the control signal, the address signal, and the like, and further resetting the storage content of the memory cells, for the convenience of the subsequent programming.

### SUMMARY OF THE INVENTION

The present invention provides an operation method for a memory. When the memory executes the reset, memory cells to be reset are first selected, and the memory cells are reset to a desired logic level, for the ease of programming.

In an embodiment of the present invention, an operation method for a memory is provided, which includes the following steps. First, the memory is set under a reset mode. Then, a main data line and a local data line of the memory are set to be a logic level. After that, a memory cell in the memory is selected by choosing a column selection line and a word line of the memory. Finally, the selected memory cell is reset according to the logic level of the main data line and the local data line.

In another embodiment of the present invention, an operation method for a memory, adapted to a memory is provided, which includes the following steps. First, a reset signal is sent, so as to reset the memory, in which a read/write signal and an address signal in the memory are reset. Then, the main data line and the local data line of the memory are forced to be a logic high level. After that, a column selection line and a word line of the memory are turned on, so as to select a memory cell of the memory. Finally, the logic high level of the main data line and the local data line is written into the selected memory cell, so as to reset the selected memory cell.

In view of the above, during the reset of the memory, in addition to the read/write signal and the address signal, a specific memory cell may be reset to be a certain level according to the requirements of programming.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a memory.

FIG. 2 is a time sequence diagram of a memory under a reset mode according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

When the memory executes the reset, in addition to the read/write signal and the address signal, the memory cells are reset, which enables the program designers to reset the memory cells at will.

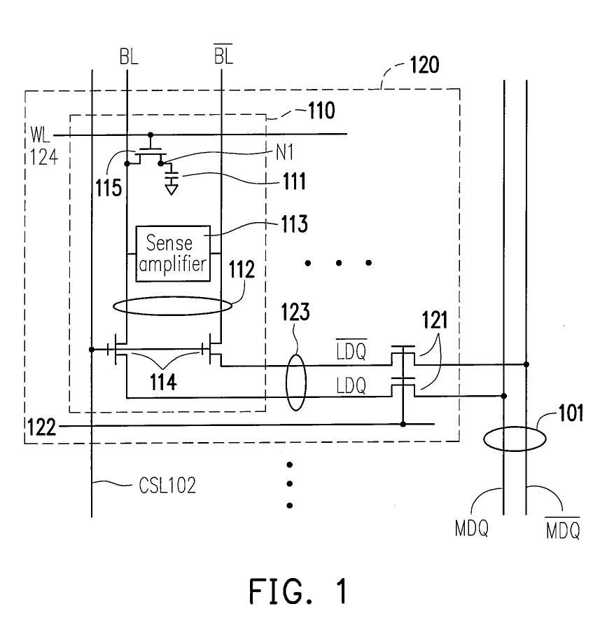

FIG. 1 is a schematic view of a memory. As shown in FIG. 1, the memory at least includes a main data line (MDQ) 101, a column selection line (CSL) 102, and a memory array 120. The memory array 120 at least includes a MDQ switch 121, a MDQ switch control line 122, a local data line (LDQ) 123, a word line (WL) 124, and a memory unit 110. The memory unit 110 includes a memory cell 111, a bit line 112, a sense amplifier 113, a column selection switch 114, and a WL switch 115. The memory cell 111 is, for example, a capacitor.

The main data line 101 includes a pair of data lines MDQ and M̅D̅Q̅ with levels complementary to each other. The local data line 123 includes a pair of data lines LDQ and L̅D̅Q̅ with levels complementary to each other. The bit line 112 includes a pair of bit lines BL and B̅L̅ with levels complementary to each other. The node N1 denotes a level of the capacitor 111. That is, when the node N1 is the logic high level, the capacitor 111 stores data of logic “1”. Otherwise, when the node N1 is the logic low level, the capacitor 111 stores data of logic “0”.

The main data line 101 is electrically connected to the memory array 120. Particularly, the main data line 101 is electrically connected to the local data line 123 through the MDQ switch 121. The control end of the MDQ switch 121 is electrically connected to the MDQ switch control line 122. When the MDQ switch control line 122 is the logic high level, the MDQ switch 121 assumes a turn-on state, such that the level of the main data line 101 is written into local data line 123, and vice versa.

The local data line 123 is connected to the bit line 112 through the column selection switch 114. The control end of the column selection switch 114 is connected to the column selection line 102. When the column selection line 102 is the logic high level, the column selection switch 114 assumes the turn-on state, such that the level of the local data line 123 is transferred to the bit line 112 through the column selection switch 114.

The sense amplifier 113 is disposed between the bit line 112. The fine voltage difference between the bit lines BL and B̅L̅ is amplified by the sense amplifier 113, such that one bit line is the logic high level, and the other bit line is the logic low level.

In an embodiment of the present invention, the MDQ switch 121, the column selection switch 114, and the capacitor 111 may be transistors, and the gates thereof are control ends. The above memory is, for example, the third-generation DDR SDRAM.

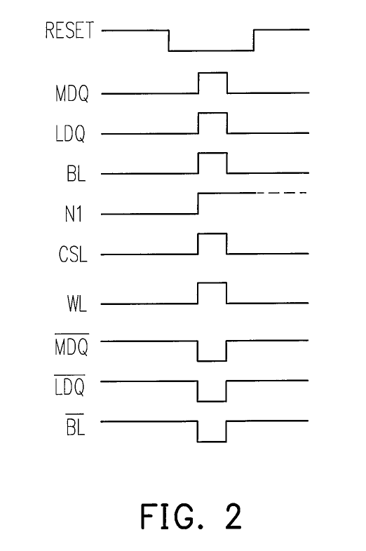

Referring to FIGS. 1 and 2 together, FIG. 2 is a time sequence diagram of a memory under a reset mode according to an embodiment of the present invention. When the memory is under a reset mode, a reset signal R̅E̅S̅E̅T̅ is the logic low level, and the MDQ switch control line 122 is the logic high level so as to turn on the MDQ switch 121. In this manner, the main data line 101 may be electrically connected to the local data line 123, i.e., the level of the main data line 101 is written into the local data line 123. In addition, under the reset mode, the levels of the main data line 101 and the local data line 123 are not necessarily the logic high level, which can be determined optionally.

Then, the column selection line 102 is set to be logic high (i.e., the column selection line 102 is selected) and the column selection switch 114 is turned on. In this manner, the level of the local data line 123 is written into the bit line 112. In addition, the word lines 124 is set to be logic high (i.e., the word lines 124 is selected) to turn on the WL switch 115, such that the level of the bit line BL is written into capacitor 111. In this manner, the level N1 of the memory cell is set to be the same as that of the main data line MDQ (i.e., the level of the main data line MDQ is written into the capacitor 111). Thus, the reset of the capacitor 111 is completed.

In view of the above, during the reset of the memory cells, if the memory cells need to be reset to the logic low level, it is only required to set the main data line MDQ to be logic low.

If a specific memory cell needs to be reset, the column selection line CSL and the word line WL are set to be logic high to turn on and reset the corresponding memory cell. In this manner, it can be determined which memory cell is reset optionally. Furthermore, all the column selection lines CSL and the word lines WL may be selected, so as to reset all the memory cells.

Therefore, the level N1 of all the memory cells can be reset to the required logic level in a standby mode, and maintained until the memory exits the standby mode.

To sum up, in the prior art, when the memory is under the reset mode, only the read/write signal, address signal, and the like can be reset. However, in the embodiments of the present invention, when the memory is under the reset mode, the main data line 101, local data line 123, bit line 114, and word line 124 are forced to be a specific logic level, and thus a specific memory cell or all the memory cells can be reset, which brings convenience to the program designers in design.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operation method for memory, adapted to a memory, comprising:
setting the memory under a reset mode;
setting a main data line and a local data line of the memory to be a logic level;
selecting a memory cell in the memory by choosing a column selection line and a word line of the memory; and
resetting the selected memory cell according to the logic level of the main data line and the local data line.

2. The operation method for memory according to claim 1, wherein the process of setting the memory under the reset mode comprises:
setting a reset signal to be a logic high level.

3. The operation method for memory according to claim 1, wherein the main data line comprises a first main data line and a second main data line, and levels of the first main data line and the second main data line are complementary to each other.

4. The operation method for memory according to claim 3, wherein the process of setting the main data line and the local data line of the memory to be the logic level comprises:
setting the first main data line to be logic high, and setting the second main data line to be logic low.

5. The operation method for memory according to claim 1, wherein the local data line comprises a first local data line and a second local data line, and levels of the first local data line and the second local data line are complementary to each other.

6. The operation method for memory according to claim 5, wherein the process of setting the main data line and the local data line of the memory to be the logic level comprises:
setting the first local data line to be logic high, and setting the second local data line to be logic low.

7. The operation method for memory according to claim 1, wherein the process of resetting the selected memory cell according to the logic level of the main data line and the local data line comprises:
writing the logic level of the main data line and the local data line into the selected memory cell, so as to reset the memory cell.

8. An operation method for memory, adapted to a memory, comprising:
sending a reset signal, so as to reset the memory, wherein a read/write signal and an address signal in the memory are reset;
forcing a main data line and a local data line of the memory to be a logic high level;
turning on a column selection line and a word line of the memory, so as to select a memory cell of the memory; and
writing the logic high level of the main data line and the local data line into the selected memory cell, so as to reset the selected memory cell.

9. The operation method for memory according to claim 8, wherein the process of sending the reset signal, so as to reset the memory comprises:
setting the reset signal to be a logic high level.

10. The operation method for memory according to claim 8, wherein the main data line comprises a first main data line and a second main data line, and levels of the first main data line and the second main data line are complementary to each other.

11. The operation method for memory according to claim 10, wherein the process of forcing the main data line and the local data line of the memory to be logic high level comprises:
setting the first main data line to be logic high, and setting the second main data line to be logic low.

12. The operation method for memory according to claim 8, wherein the local data line comprises a first local data line and a second local data line, and levels of the first local data line and the second local data line are complementary to each other.

13. The operation method for memory according to claim 12, wherein the process of forcing the main data line and the local data line of the memory to be logic high level comprises:
setting the first local data line to be logic high, and setting the second local data line to be logic low.
